(19) United States
(12) Patent Application Publication
(10) Pub. No.: US 2008/0131840 A1
(43) Pub. Date: Jun. 5, 2008

(54) IMPLANT ROOT FOR TOOTH IMPLANTING

(76) Inventor: Chun-Leon Chen, Changhua City (TW)

Correspondence Address: SINORICA, LLC, 528 FALLSGROVE DRIVE, ROCKVILLE, MD, 20850, US

(21) Appl. No.: 11/564,911

(22) Filed: Nov. 30, 2006

(51) Int. Cl. A61C 8/00

(52) U.S. Cl. 433/174

(57) ABSTRACT

An improved implant root for tooth implanting, a coarse threaded portion of the implant root is formed to have at least two helical treating surfaces each with an HA coating (covered with hydroxyapatite) and each extending in the vertical direction. The areas of the HA coatings can thus be increased in favor of fast growth of a bone of a denture base after implanting into the bone to envelop the implant root; this can shorten the curing process from implanting the implant root to mounting a crown.

### BACKGROUND OF THE INVENTION

1. Field of the Invention

The present invention relates to an improved implant root for tooth implanting, and especially to an implant root of which a coarse threaded portion is formed to have at least two helical treating surfaces each with an HA coating and each extending in the vertical direction.

2. Description of the Prior Art

The history of the technique of tooth implanting in an oral cavity has been several decades of years; the technique mainly has a tooth on a denture base of a patient pulled out, then an implant root made of metal is implanted into the bone of the denture base of the patient; after the bone grows to envelop the implant root, the tooth implanting work is completed when the implant root is covered with a crown. The advantage of the work is the saving of abrading the true tooth that can solely support and fix the crown. And the false tooth implanted has increased biting force and holding force that reduce inconvenience and discomfort of a patient.

FIG. 1 shows an implant root habitually used presently; basically, the implant root is made of pure titanium or titanium alloy, it has on its upper area a connecting portion 91 to connect with an abutment of the crown, and has on its lower area a sharp threaded portion 92. A horizontal treating surface 93 is provided between the connecting portion 91 and the threaded portion 92; the treating surface 93 is covered with hydroxyapatite similar to the material of human bone with the component of Ca₁₀(PO₄)₆(OH₂), also called as HA coating; the treating surface 93 has a function to combine with a growing bone, so that after implanting of the implant root into a denture base, the implant root can be firmly embedded in the denture base when the growth of the bone is completed, then the crown can be mounted.

With the structure of the implant root, the treating area of the HA coating is small, its ability of helping growth of the bone is inferior, the implant root being implanted is less firm, and improvement is wanted.

### SUMMARY OF THE INVENTION

The present invention is an improvement on the defect of the conventional implant root structure, wherein a coarse threaded portion of the implant root is formed to have at least two helical treating surfaces each with an HA coating and each extending in the vertical direction, thereby, the areas of the HA coatings can be increased in favor of fast growth of a bone to envelop the implant root, and by shrinking by volume of the coarse threaded portion, the space for growth of the bone in a denture base thus is increased; by virtue that the growing bone can be combined with the helical treating surfaces of the HA coatings, firmness of the implant root implanting into the denture base can be increased, and the time for waiting for mounting the crown can be reduced.

The improved implant root provided in the present invention can have the cutting force for implanting the implant root increased during implanting of the implant root into the denture base by extending in the vertical direction of helical treating surfaces of the coarse threaded portion, and the bone dusts in the denture base will stay in the treating surfaces, thereby the implant root can be smoothly inserted in the bone.

The treating surfaces of improved implant root provided in the present invention can be plane or recessed arciform surfaces; this further increases the areas of the treating surfaces and the space for staying of the bone dusts.

According to the present invention, the treating surfaces can be at least two plane surfaces or more than three arciform surfaces laid out in an equiangularly spaced away mode and all extending in the vertical direction.

The present invention will be apparent in its structure and its way of using after reading the detailed description of the preferred embodiment thereof in reference to the accompanying drawings.

### BRIEF DESCRIPTION OF THE DRAWINGS

FIG. 1 is a perspective view showing the appearance of a conventional implant root;

FIG. 2 is a perspective view showing the appearance of the first embodiment of the present invention;

FIG. 3 is a sectional view taken from an A-A sectional line in FIG. 2;

FIG. 4 is a perspective view showing the appearance of the second embodiment of the present invention;

FIG. 5 is a sectional view taken from a B-B sectional line in FIG. 4; and

FIG. 6 is a sectional view taken from FIG. 2 showing its front side of the second preferred embodiment of the present invention with an abutment connected;

FIG. 7 is an exploded perspective view from FIG. 2.

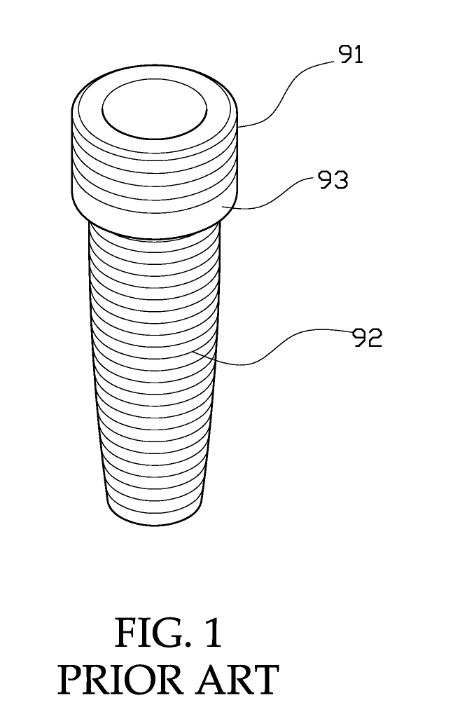

### DETAILED DESCRIPTION OF THE PREFERRED EMBODIMENT

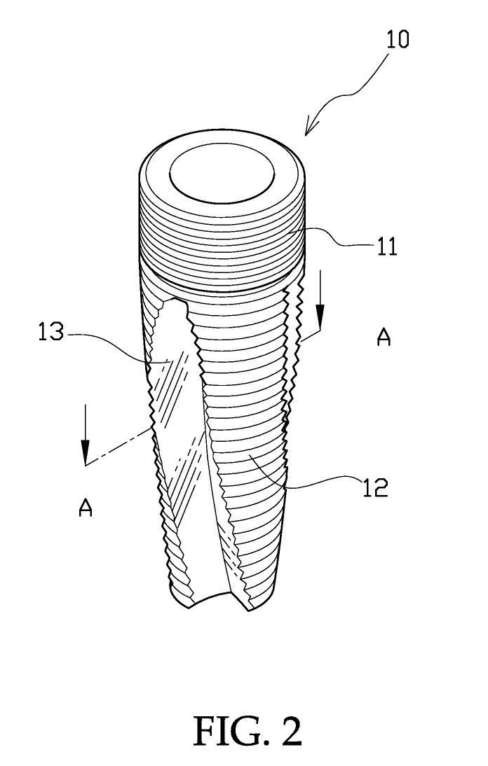

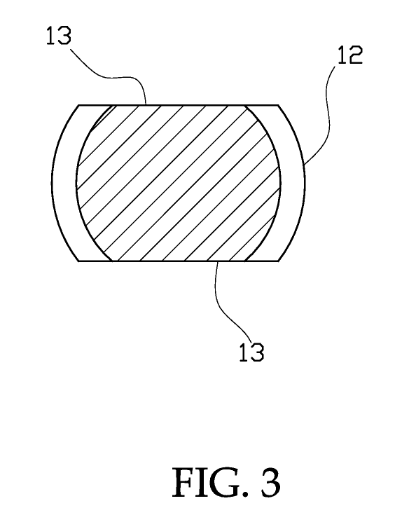

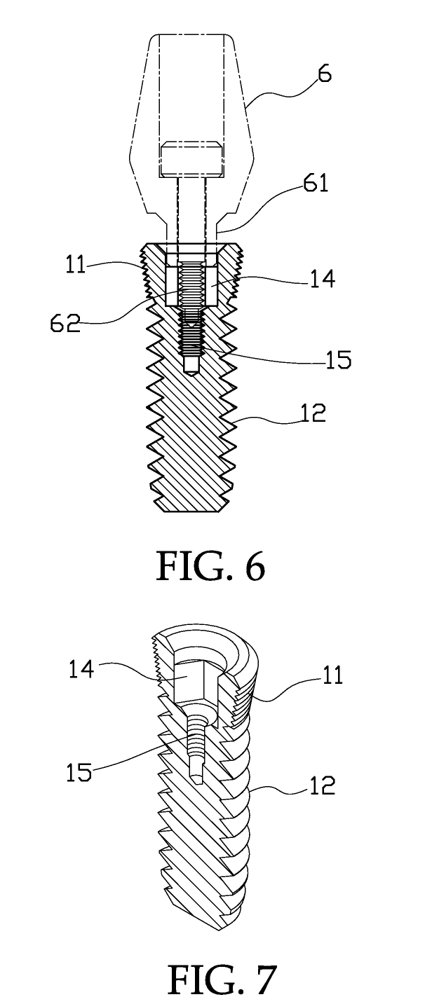

Referring to FIGS. 2 and 3 showing the first embodiment of the present invention, wherein an implant root 10 has on its upper area a connecting portion 11, the connecting portion 11 has on its outer surface a fine threaded portion, and the implant root 10 has on its lower area a coarse threaded portion 12. The connecting portion 11 is connected with an abutment 6 of a crown such as is shown in FIG. 6; the surfaces of the coarse threaded portion 12 have sharp threads that can be implanted in a denture base of a patient by rotation.

Two helical treating surfaces 13 formed on the coarse threaded portion 12 extending in the vertical direction are treated with HA coatings. Thereby the areas of the helical treating surfaces 13 are larger than the area of the conventional horizontal treating surface 93, and thereby the bone of the denture base can get fast growth to envelop the implant root 10; further by combining of the treating surfaces 13 having the HA coatings extending in the vertical direction, firmness of the implant root 10 implanting into the denture base can be increased, and the time for waiting for mounting the crown can be reduced. And further, by extending in the vertical direction of the treating surfaces 13 of the coarse threaded portion 12, during implanting the implant root 10 in the denture base, the bone dusts in the denture base will stay in the treating surfaces 13, thereby the implant root 10 can be smoothly inserted in the bone.

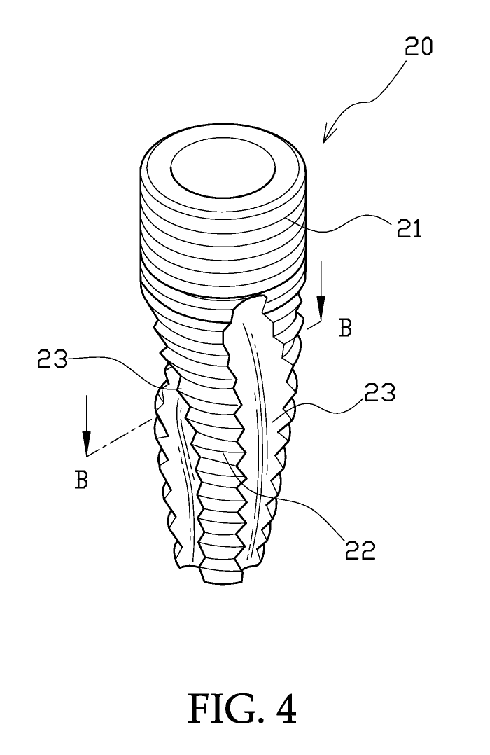

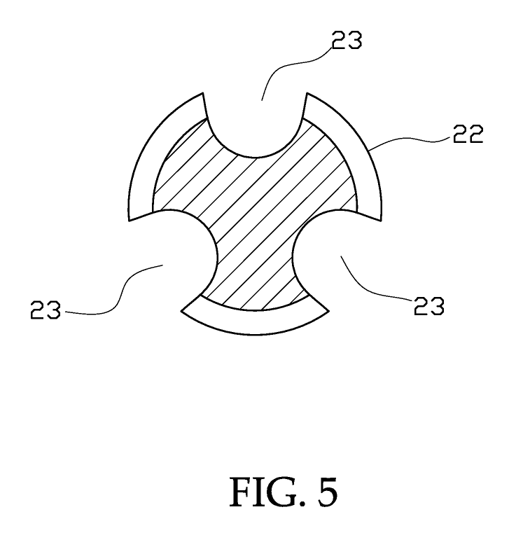

Referring to FIGS. 4 and 5 showing the second embodiment of the present invention, wherein an implant root 20 has a connecting portion 21, the connecting portion 21 has on its outer surface a fine threaded portion, and the implant root 20 has on its lower area a coarse threaded portion 22. The coarse threaded portion 22 has three arciform surfaces 23 laid out in an equiangularly spaced away mode and all extending in the vertical direction and are treated with HA coatings, the three arciform surfaces 23 are recessed arciform surfaces (referring to FIG. 5) to further increase the areas of the treating surfaces and the space for staying of the bone dusts.

Referring to FIGS. 6 and 7, the connecting portion 11 is provided with a polygonal hole 14, a screw hole 15 is provided in the bottom surface of the polygonal hole 14. Wherein the polygonal shape of the polygonal hole 14 is mated with the shape of a connecting section 61 of the abutment 6, so that the abutment 6 can be fast and correctly positioned when in connecting with the implant root 10, and a bolt 62 on the bottom of the abutment 6 can be smoothly rotated to connect into the screw hole 15 of the implant root 10, and thus connection is completed. If incorrect positioning is resulted, the bolt 62 will be too short to be locked in the hole screw hole 15; thereby the situation of incorrect positioning can be completely prevented.

In conclusion, according to the description disclosed above, the improved implant root provided by the present invention has the novelty and improvement that a patent should have. And the embodiments given are only for illustrating the present invention; it will be apparent to those skilled in this art that various equivalent modifications or changes without departing from the spirit of this invention, such as increasing or shape changing of the treating surfaces, shall also fall within the scope of the appended claims.

1. An improved implant root for tooth implanting into a bone of a denture base of a patient, said implant root comprises:
a connecting portion having on its outer surface a fine threaded portion connected with an abutment of a crown;
a coarse threaded portion on a lower area below said connecting portion, surfaces of said coarse threaded portion have sharp threads;
at least two helical treating surfaces formed on said coarse threaded portion and extending in a vertical direction, said treating surfaces are treated with HA coatings.

2. The improved implant root tooth implanting as claimed in claim 1, wherein said at least two helical treating surfaces are plane surfaces.

3. The improved implant root tooth implanting as claimed in claim 1, wherein said at least two helical treating surfaces are more than three arciform surfaces laid out in an equiangularly spaced away mode.

4. The improved implant root tooth implanting as claimed in claim 1, wherein said connecting portion is provided with a polygonal hole, a screw hole is provided in a bottom surface of said polygonal hole, a polygonal shape of said polygonal hole is mated with a shape of a connecting section of said abutment of said crown, so that said abutment is fast and correctly positioned when in connecting with said implant root, and a bolt on a bottom of said abutment is adapted to being smoothly rotated to connect into said screw hole.
